(19) United States
(12) Patent Application Publication
(10) Pub. No.: US 2004/0184385 A1
(43) Pub. Date: Sep. 23, 2004

(54) Aperture limiting element and optical pickup device utilizing it

(76) Inventors: Toshiaki Katsuma, Tokyo (JP); Tetsuya Ori, Koshigaya City (JP); Yu Kitahara, Saitama City (JP)

Correspondence Address: Arnold International, P. O. BOX 129, Great Falls, VA, 22066, US

(21) Appl. No.: 10/801,826

(22) Filed: Mar. 17, 2004

(30) Foreign Application Priority Data
Mar. 18, 2003 (JP) 2003-074523

(51) Int. Cl. G11B 7/135

(52) U.S. Cl. 369/118

(57) ABSTRACT

An aperture limiting element that has a wavelength selectivity is disclosed wherein an aperture that is an open space of a specified size formed in a substrate and, in an area outside the aperture and that surrounds the aperture, a light filter is provided wherein light of a specified wavelength λ1 is transmitted straight through, and light of a wavelength λ2 is prevented from passing straight through. Alternatively, the light filter may be provided with an inner first region that transmits light of first and second wavelengths λ2 and λ2, respectively, and does not transmit straight through light of a third wavelength λ3, where λ1<λ2<λ3; and in an area outside of the inner first region, there is constructed an outer second region that transmits light of the first wavelength λ1, and does not transmit straight through light of the second and the third wavelengths λ2 and λ3.

### BACKGROUND OF THE INVENTION

Recently, various kinds of optical recording media have been developed, and optical pickup devices which can be used for recording and playback of multiple kinds of optical recording media are known. For example, an apparatus has been developed which records and plays back DVD (Digital Versatile Disk) and CD-R (Compact Disk Recordable) using one optical pickup device.

When playing back a large-capacity DVD, the diameter of the condensed-light spot on the disk surface needs to be reduced corresponding to the narrow track pitch. Because the diameter of a condenised-light spot is inversely proportional to the numerical aperture of the objective lens and is proportional to the wavelength of light used, when playing back such a DVD, it is necessary to enlarge the numerical aperture of the objective lens to about 0.6 and to shorten the wavelength of the light used for playback to about 650 nm as compared to the playback conditions for a CD-R disk.

On the other hand, a CD-R disk has a smaller disk capacity than a DVD, and the numerical aperture of the objective lens is desirably in the range of about 0.45-0.5. Also, because CD-R disks are designed so that high reflectivity is obtained only for incident light having wavelengths near 780 nm, the wavelength of light used in playing back CD-R disks needs to be about 780 nm.

In this way, because DVD's and CD-R's have different optimal wavelengths and different objective lens numerical apertures during recording/playback, in an optical pickup device which can be used to play back either of these different types of recording media, it is common that a two-wavelength method is adopted wherein light having two different wavelengths is used as the irradiating light, and the construction is such that the numerical aperture of the objective lens during playback is varied according to the optical recording medium that is being used.

Japanese Laid-Open Patent Application H9-198700 discloses using a variable stop that may be either a mechanical shutter or a liquid crystal shutter that is placed on the light source side of an objective lens in order to change the numerical aperture when irradiating light of different wavelengths onto different types of optical recording media that require different numerical apertures. However, use of such a variable stop makes the construction complex and causes the size of the device to increase.

Recently, attention has been given to an aperture limiting element which employs a wavelength selective, absorbing filter and a phase compensation film on a transparent substrate, with the aperture limiting element thus having a wavelength selectivity. As shown in FIG. 20, such an aperture limiting element may be placed on the light-source side of an objective lens 102, as shown in FIG. 20, and used to automatically adjust the numerical aperture of the objective lens 102 according to the wavelength of the incident light flux. In an optical pickup device, laser light output from a semiconductor laser light source (not shown) may be collimated by a collimator lens (not shown), reflected by a reflective prism 105, and then enters into an objective lens 102 via the aperture limiting element 104 and a stop 103, where it is focused by the objective lens 102 so as to irradiate a recording area that approximately coincides with the backside of a transparent protective plate 101 of an optical disk 106.

The aperture limiting element 104 is made by installing a wavelength selective film outside a central circular area on a transparent substrate. The wavelength selective film functions to transmit almost all the light of wavelength 635 nm and to reflect almost all the light of wavelength 780 nm. The wavelength selective film includes a phase compensation film which has a function of adjusting the optical path difference for light passing through the wavelength selective film and the phase compensation film versus light passing through air to m·λ, where m is a positive integer. The aperture limiting element 104 transmits light of wavelength 635 nm and reflects or absorbs light of wavelength 780 nm in the area outside the central circular area and, on the other hand, transmits light of both of these wavelengths within the central circular area. Thus, by means of the aperture limiting element being composed of a wavelength selective film, light of wavelength 635 nm is given a light flux diameter corresponding to a numerical aperture of 0.6, and light of wavelength 780 nm is given a light flux diameter corresponding to a numerical aperture of 0.45.

Japanese Laid-Open Patent Application H9-54977 discloses an aperture limiting element that uses a wavelength-selective, diffractive film in lieu of using a wavelength-selective, absorbing film, but otherwise the wavelength-selective film has the same function as discussed in the paragraph above.

Because the arrangement disclosed in Japanese Laid-Open Patent Application H9-54977 uses a plate-shaped, aperture limiting element on the light-source side of the objective lens, light reflected from each of the front and back surfaces of the aperture limiting element may be returned to the light-source side, making the oscillation of the semiconductor laser light source become unstable. Although there is a method of coating an antireflective film on the surface of such an aperture limiting element to thereby reduce the amount of reflected light, this method is not sufficient to prevent reflected light from being returned to the light-source side and causing problems. The problem of unwanted light being returned to the light source and thereby making the oscillation of the light source unstable is not limited to optical pickup devices used for playing back either DVD or CD-R optical recording media, but is a problem that, in general, occurs in optical pickup devices for recording and playing back different types of optical disks that require different wavelengths and different numerical apertures of the playback light beams.

Also, there is presently an urgent demand for a significant reduction in thickness of optical pickup devices. As a general recent trend, as evidenced by Japanese Laid-Open Patent Application H9-54977, the objective lens has a convex surface that projects toward the light-source side. Therefore, a margin of space is necessary in the optical axis direction so that the surfaces of the objective lens 102 and the aperture limiting element 104 will not damage one another by coming into contact. Also, space is necessary for the thickness of the aperture limiting element 104 itself, and these demands are contrary to the demand for thickness reduction.

### BRIEF SUMMARY OF THE INVENTION

The present invention relates to an aperture limiting element and an optical pickup device utilizing it wherein the optical pickup device is capable of reading optical recording media of multiple types recorded with different wavelengths and different numerical apertures of irradiating light beams. More particularly, the aperture limiting element of the present invention greatly reduces the amount of light that is reflected at the surface of the aperture limiting element and is then returned to the laser light source, thereby causing unwanted instability in the laser light source, while enabling the recent demand for thickness reduction of optical pickup devices to be met even when the aperture limiting element is placed on the optical axis of the optical pickup device.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 shows the main section of an optical pickup device that utilizes an aperture limiting element according to the present invention;

FIG. 2 shows an aperture limiting element of a first mode according to the present invention;

FIG. 3 shows an aperture limiting element of a second mode according to the present invention;

FIG. 4 shows an aperture limiting element of a third mode according to the present invention;

FIG. 5 shows an aperture limiting element of a fourth mode according to the present invention;

FIGS. 6A and 6B show an aperture limiting element according to Embodiment 1, with FIG. 6A being a view as seen along the optical axis, and FIG. 6B being a side cross-sectional view;

FIGS. 7A and 7B show an aperture limiting element according to Embodiment 2, with FIG. 7A being a view as seen along the optical axis, and FIG. 7B being a side cross-sectional view;

FIGS. 8A and 8B show an aperture limiting element according to Embodiment 3, with FIG. 8A being a view as seen along the optical axis, and FIG. 8B being a side cross-sectional view;

FIGS. 9A and 9B show an aperture limiting element according to Embodiment 4, with FIG. 9A being a view as seen along the optical axis, and FIG. 9B being a side cross-sectional view;

FIGS. 10A and 10B show an aperture limiting element according to Embodiment 5, with FIG. 10A being a view as seen along the optical axis, and FIG. 10B being a side cross-sectional view;

FIGS. 11A and 11B show an aperture limiting element according to Embodiment 6, with FIG. 11A being a view as seen along the optical axis, and FIG. 11B being a side cross-sectional view;

FIGS. 12A and 12B show an aperture limiting element according to Embodiment 7, with FIG. 12A being a view as seen along the optical axis, and FIG. 12B being a side cross-sectional view;

FIGS. 13A and 13B show an aperture limiting element according to Embodiment 8, with FIG. 13A being a view as seen along the optical axis, and FIG. 13B being a side cross-sectional view;

FIGS. 14A and 14B show an aperture limiting element according to Embodiment 9, with FIG. 14A being a view as seen along the optical axis, and FIG. 14B being a side cross-sectional view;

FIGS. 15A and 15B show an aperture limiting element according to Embodiment 10, with FIG. 15A being a view as seen along the optical axis, and FIG. 15B being a side cross-sectional view;

FIGS. 16A and 16B show an aperture limiting element according to Embodiment 11, with FIG. 16A being a view as seen along the optical axis, and FIG. 16B being a side cross-sectional view;

FIGS. 17A and 17B show an aperture limiting element according to Embodiment 12, with FIG. 17A being a view as seen along the optical axis, and FIG. 17B being a side cross-sectional view;

FIGS. 18A and 18B show an aperture limiting element according to Embodiment 13, with FIG. 18A being a view as seen along the optical axis, and FIG. 18B being a side cross-sectional view;

FIGS. 19A and 19B show an aperture limiting element according to Embodiment 14, with FIG. 19A being a view as seen along the optical axis, and FIG. 19B being a side cross-sectional view;

FIG. 20 is a schematic diagram showing the main section of an optical pickup device of the prior art technology; and

FIG. 21 is a schematic diagram showing an optical pickup device that uses an aperture limiting element according to the present invention.

### DETAILED DESCRIPTION

The aperture limiting element according to a first feature of the present invention includes a wavelength selective element that is positioned on the light-source side of an objective lens for an optical pickup device and is characterized by there being an aperture that is an open space of a specified size formed in a substrate, with an area surrounding the aperture constructed so that light of a specified wavelength is selectively transmitted straight through this area while transmission of other wavelengths of light straight through this area is prevented.

It is preferable that the area of substrate surrounding the aperture be constructed so that light of a first wavelength λ1 is transmitted and light of a second wavelength λ2 is blocked.

Alternatively, the area surrounding the aperture in the substrate may be constructed so that light of the first wavelength λ1 is transmitted, and light of the second wavelength λ2 is diffracted to the side so as to be effectively not transmitted. In such a case, it is preferable that the difference between the optical path length of light of the first wavelength λ1 which transmits through the aperture limiting element versus the optical path length of light of the first wavelength λ1 which passes through open space within the outer boundary of the aperture is m λ1, where m is a positive integer.

The aperture limiting element according to a second feature of the present invention includes a wavelength selective element that is positioned on the light-source side of an objective lens used for optical pickup and is characterized by there being: (1) an aperture having open space of a specified size is formned in a central region of a substrate; (2) outside the aperture, an inner first region is constructed so that the aperture limiting element in this region transmits light of the first and second wavelengths λ1 and λ2 and blocks light of a third wavelength λ3; and (3) outside the inner first region, an outer second region is constructed that the aperture limiting element in this region transmits light of the first wavelength λ1 and blocks light of the second and third wavelengths λ2 and λ3.

The aperture limiting element according to a third feature of the present invention includes a wavelength selective element that is placed on the light-source side of an objective lens for an optical pickup device and is characterized by there being: (1) an aperture formed in a central region of the substrate having an open space of a specified size within a outer boundary of the aperture; (2) outside the aperture, an inner first region is constructed so that the aperture limiting element in this region transmits light of the first and second wavelengths λ1 and λ2 and blocks light of a third wavelength λ3; and (3) outside the inner first region, an outer second region is constructed that the aperture limiting element in this region transmits light of the first wavelength λ1 and, for light of wavelengths λ2 and λ3, this region diffracts one and blocks the other so that substantially no light of wavelengths λ2 and λ3 passes straight through this region.

Also, in the aperture limiting element as described in the paragraph immediately above, it is preferable that the construction is such that the difference in the optical path length between light of the first wavelength λ1 that is transmitted by the aperture limiting element and the optical path length of light of the first wavelength λ1 which passes through the open space within the outer boundary of the aperture is m·λ1, where m is a positive integer, and that the difference between the optical path length of light of the second wavelength λ2 that is transmitted by the aperture limiting element versus the optical path length of light of the second wavelength λ2 which passes through the open space within the outer boundary of the aperture is n·λ2, where n is a positive integer.

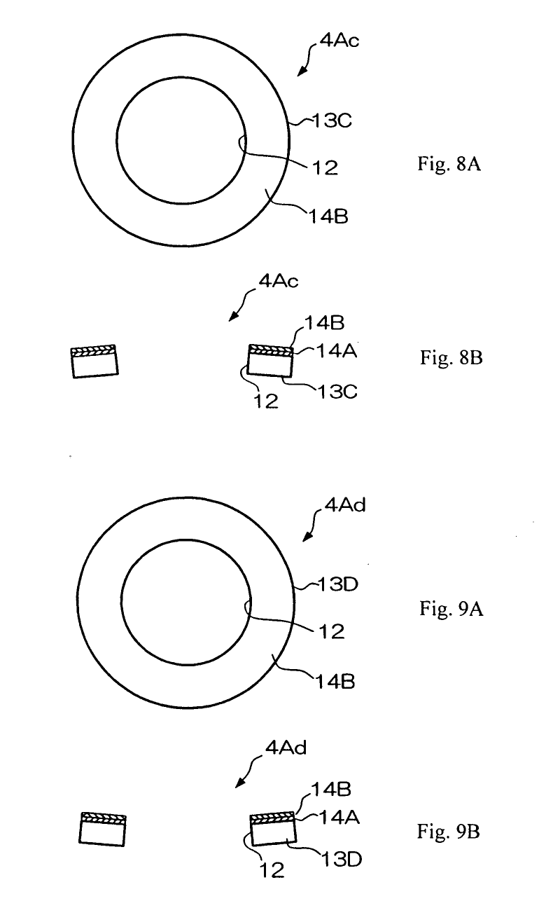

Also, it is preferable that the substrate, instead of being planar, is given a very shallow V shape (as illustrated in FIG. 9B) or a very shallow inverted V shape centered about the aperture in the substrate (as illustrated in FIG. 8B). Where the substrate is not planar in shape, it is preferable that the substrate be formed of plastic material.

Also, it is preferable that the aperture limiting element be constructed such that the ratio of the intensity of the zero-order diffracted light of the first wavelength λ1 divided by the light of the first wavelength λ1 that is transmitted by the aperture limiting element be 85% or higher, and that the ratio of the intensity of the zero-order diffracted light of the second wavelength λ2 divided by the light of the second wavelength λ2 that is transmitted by the aperture limiting element be less than the ratio of the light intensity of a specified diffracted order (such as the +1^{st} order or the −1^{st} order) of light of the second wavelength λ2 divided by the light of the second wavelength λ2 that is transmitted by the aperture limiting element.

It is possible to construct the aperture limiting element so that the shape of diffraction grating elements formed on the substrate as seen from the optical axis direction form concentric circles.

It is possible to construct the aperture limiting element so that the cross-sectional shape of the diffraction grating elements formed on the substrate, have the shape of stairs. In such a case, it is preferable that the diffraction direction of light of the second wavelength λ2 or that the diffraction direction of light of the third wavelength λ3 is such that the light initially diverges from the optical axis.

The optical pickup device of the present invention is characterized by having one of the aperture limiting elements as described above. Also, it is preferable that the objective lens be a positive lens having a convex surface on the light-source side and that the convex surface is partially inserted within the aperture of the aperture limiting element.

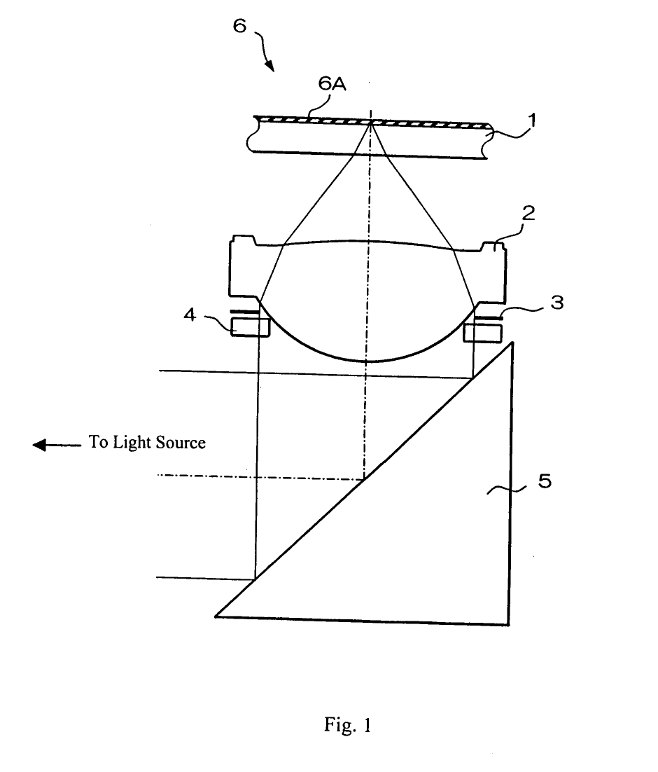

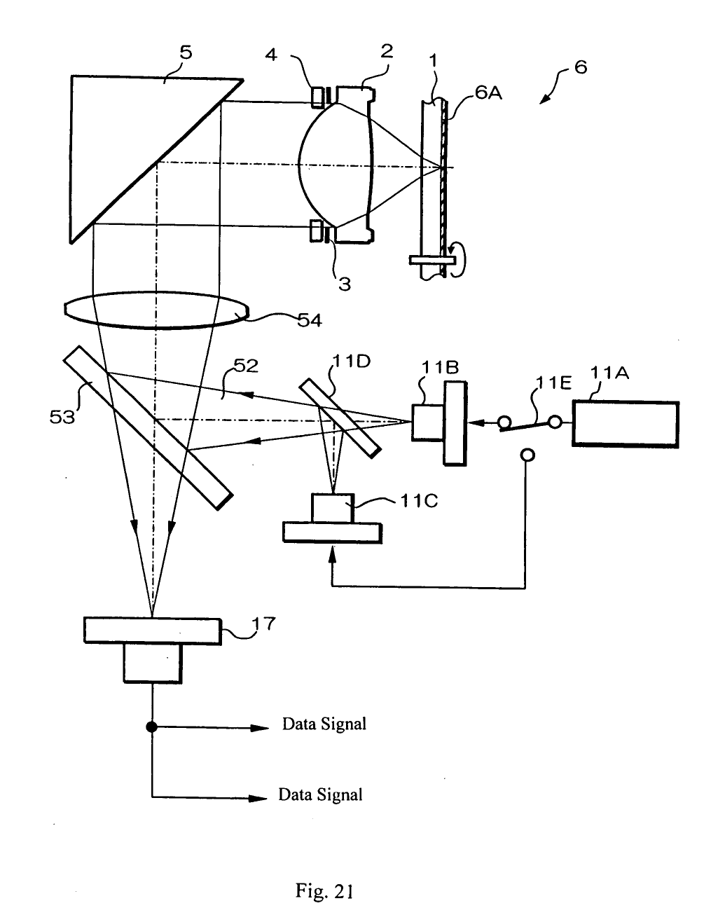

A general description of an aperture limiting element according to the present invention and an optical pickup device utilizing it will now be given with reference to FIG. 1 and FIG. 21.

Referring first to FIG. 21, in an optical pickup device a laser beam 52 that is output from one of semiconductor lasers 11B and 11C that are powered by an electric power supply 11A is reflected by a half-reflecting mirror 53. The light is then collimated by a collimator lens 54, reflected by a reflective prism 5, and is incident onto an objective lens 2 via an aperture limiting element 4 and a stop 3. The objective lens 2 focuses the light onto a recording area 6A of an optical disk 6, which has a transparent protective plate 1 for protecting the recording area 6A of the optical disk.

The objective lens 2 has positive refractive power and a convex surface that projects toward the light-source side, and the convex surface is designed to be precisely inserted within the aperture of the aperture limiting element 4.

The semiconductor laser 11B is a light source suitable for CD-R (Compact Disk Recordable) recording/playback which outputs a laser beam of wavelength 780 nm (the near-infrared region) and the semiconductor laser 11C is a light source suitable for DVD (Digital Versatile Disk) recording/playback which outputs a laser beam of wavelength 650 nm (the visible region), for example. The laser beam 52 that is output via a half-reflecting mirror 11D from one of the semiconductor lasers 11B and 11C is irradiated onto the half-reflecting mirror 53. Placed between the power supply 11A and the semiconductor lasers 11B and 11C is a switch 11E for supplying electric power to one of the semiconductor lasers 11B and 11C.

Arranged on the recording area 6A in tracks are bits that carry signal information. During playback, light from the laser beam 52 is reflected from the recording area 6A, travels to the objective lens 2, the stop 3, the aperture limiting element 4, the reflective prism 5, and the collimator lens 54, and is transmitted by the half-reflecting mirror 53, and is then incident onto a photo diode 17 that has been divided in four quadrants. The amount of received light at each of four divided quadrants of the photo diode is determined so as to obtain data signals and error signals used in focusing and tracking.

Because the half-reflecting mirror 53 is positioned in the light path with its surface normal inclined at an angle of 45° to the path of returned light from the optical disk 6, it has an effect that is equivalent to there being a cylindrical lens in the light path, in that astigmatism is generated in the light beam that is transmitted by this half-reflecting mirror 53. Further, the amount of focusing error is determined according to the beam spot shape of this returned light on the photo diode 17, the detecting surface of which has been divided into four quadrants. The collimator lens 54 can be omitted, and it is further possible to insert a diffraction grating between the semiconductor lasers 11B and 11C and the half-reflecting mirror 53 so as to detect tracking errors using three beams.

The optical pickup device is constructed so that recording/playback of signals can be performed for optical disks 6 of multiple types, such as either a CD-R or a DVD.

As shown in FIG. 1, the aperture limiting element 4 is a plate-shaped element having a circular aperture (i.e., an open space that passes all wavelengths) centered about an optical axis, with a wavelength filtering film that has a wavelength selectivity or a diffraction film that has a wavelength selectivity formed on the area that surrounds the circular aperture and is constructed so light of wavelength 650 nm is transmitted straight through, and light of wavelength 780 nm is reflected or diffracted so that it is not transmitted straight through.

Thus, construction is such that the numerical aperture of the objective lens is varied according to the wavelength of light used so that, when recording or playing back a DVD (λ=650 nm), the numerical aperture of the objective lens 2 is made as large as about 0.6 and—on the other hand—when recording or playing back a CD-R (λ=780 nm), the numerical aperture of the objective lens 2 becomes as small as about 0.45.

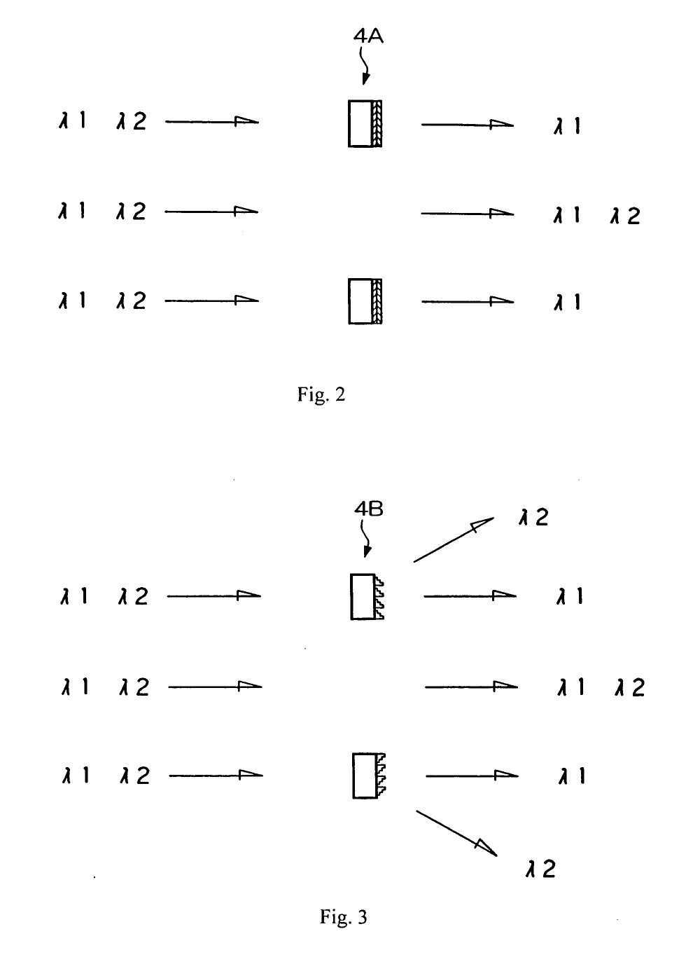

More specifically, referring to the aperture limiting element 4A shown in FIG. 2, the aperture transmits light of wavelengths λ1=650 nm and λ2=780 nm (that correspond to wavelengths used in the two-wavelength mode discussed below), a wavelength filtering film and a phase compensation film are formed on the optical-disk-side surface of the substrate that surrounds the aperture. The wavelength filtering film transmits light of wavelength λ1 straight through and reflects or absorbs light of the other wavelength λ2. In this manner, the numerical aperture of the objective lens 2 is set to a large value for light of wavelength λ1 and a small value for light of wavelength λ2. In FIGS. 2, 4 and 5, the light that is reflected or absorbed by the wavelength filtering film is not shown.

Alternatively, as in the aperture limiting element 4B shown in FIG. 3, construction is such that the aperture transmits light of wavelengths λ1 and λ2, and a diffraction filtering film is formed on the optical-disk-side surface of the substrate that surrounds the aperture. The diffraction filtering film transmits straight through only light of the wavelength λ1 and diffracts light of the other wavelength λ2 in a direction away from the optical axis.

As mentioned above, it is preferable that the aperture limiting element be constructed such that the ratio of the intensity of the zero-order diffracted light of the first wavelength λ1 divided by the light of the first wavelength λ1 that is transmitted by the aperture limiting element be 85% or higher, and that the ratio of the intensity of the zero-order diffracted light of the second wavelength λ2 divided by the light of the second wavelength λ2 that is transmitted by the aperture limiting element be less than the ratio of the intensity of a specified diffracted order (such as the +1^{st} order or the −1^{st} order) of light of the second wavelength λ2 divided by the light of the second wavelength λ2 that is transmitted by the aperture limiting element.

Also, there may be numerical apertures which correspond to light of three different wavelengths, or more.

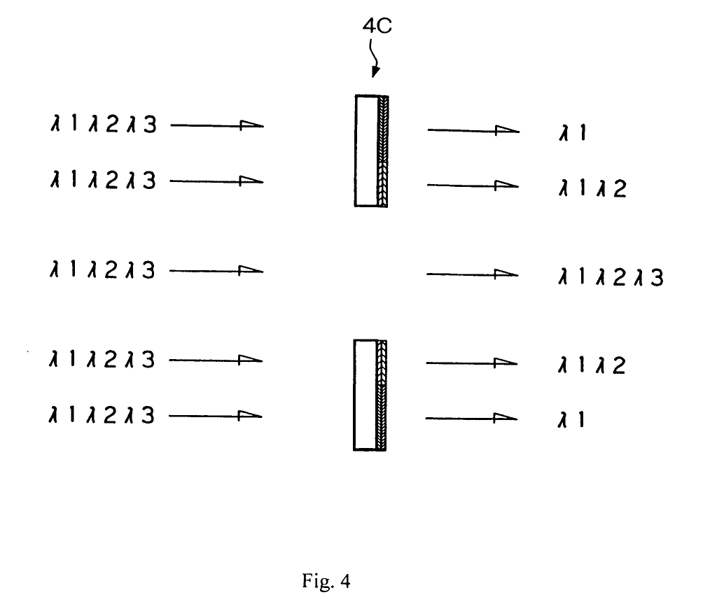

For example, as in the aperture limiting element 4C shown in FIG. 4, while the aperture obviously transmits light of the wavelengths λ1 (corresponding to a utilized wavelength of 405 nm) λ2 (corresponding to a utilized wavelength of 650 nm) and λ3 (corresponding to a utilized wavelength of 780 nm), there are formed on the substrate surface nearest the optical-disk within an inner region that surrounds the aperture and an outer region that surrounds the inner region a wavelength filtering film and a phase compensation film. The optical characteristic of the film is different between the inner region and the outer region. Thus, the wavelength range of transmitted light is different. The inner region is constructed so that the aperture limiting element in this region transmits only the λ1 and λ2 wavelength light straight through and reflects (or absorbs) the light of wavelength λ3. On the other hand, the outer region transmits only the λ1 wavelength light and reflects (or absorbs) the light of the other two wavelengths λ2 and λ3. In this case, the construction is such that the difference between the optical path length of light of the first wavelength λ1 that is transmitted by the aperture limiting element and the optical path length of light of the first wavelength λ1 that passes within the open space of the aperture is m·λ1, where m is a positive integer. Also, the difference between the optical path length of light of the second wavelength λ2 that is transmitted by the outer region of the aperture limiting element and the optical path length of light of the second wavelength λ2 that passes within the open space of the aperture is n·λ2, where n is a positive integer.

Thus, the numerical aperture of the objective lens 2 may be set to a large value for light of wavelength λ1, an intermediate value for light of wavelength λ2, and a small value for light of wavelength λ3.

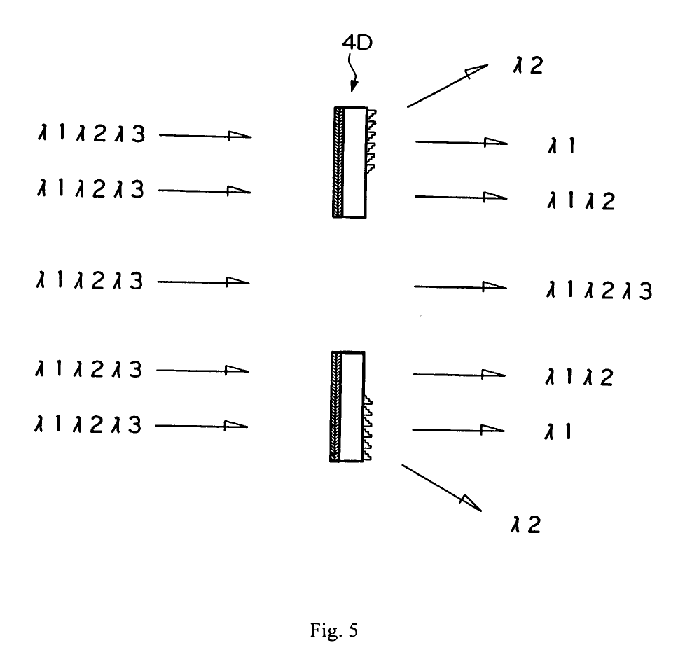

Alternatively, the aperture limiting element may be constructed as in the aperture limiting element 4D shown in FIG. 5. Namely, the aperture transmits light of three wavelengths λ1, λ2, and λ3. A wavelength filtering film and a phase compensation film are formed on the light-source-side surface of the surrounding section (both the inner region and the outer region), and a diffraction filtering film is formed on the optical-disk-side surface of the outer region.

According to this construction, among light of three different wavelengths λ1, λ2, and λ3, the inner region transmits straight through only light of wavelengths λ1 and λ2 and reflects (or absorbs) light of wavelengths λ3, and the outer region transmits straight through only light of wavelength λ1, reflects (or absorbs) light of wavelength λ3, and diffracts away from the optical axis light of wavelength λ2. In this manner, the numerical aperture of the objective lens 2 is set to a large value for light of wavelength λ1, an intermediate value for light of wavelength λ2, and a small value for light of wavelength λ3.

Also, as stated above, the objective lens 2 may be made to be a positive lens with a convex surface on the light-source side, and designed so that the convex surface section may be precisely inserted into the aperture of the aperture limiting element 4. Such a construction makes it unnecessary to provide additional space in the optical-axis direction for placing the aperture limiting element 4. Also, because an aperture is installed in the aperture limiting element 4, there is no optical surface which reflects light backward along the optical axis direction in a manner that causes the oscillation of the semiconductor lasers 11B and 11C to become unstable.

Specific designs of the aperture limiting element 4 of the present invention will now be explained in detail in discussing the following embodiments of the present invention.

### Embodiment 1

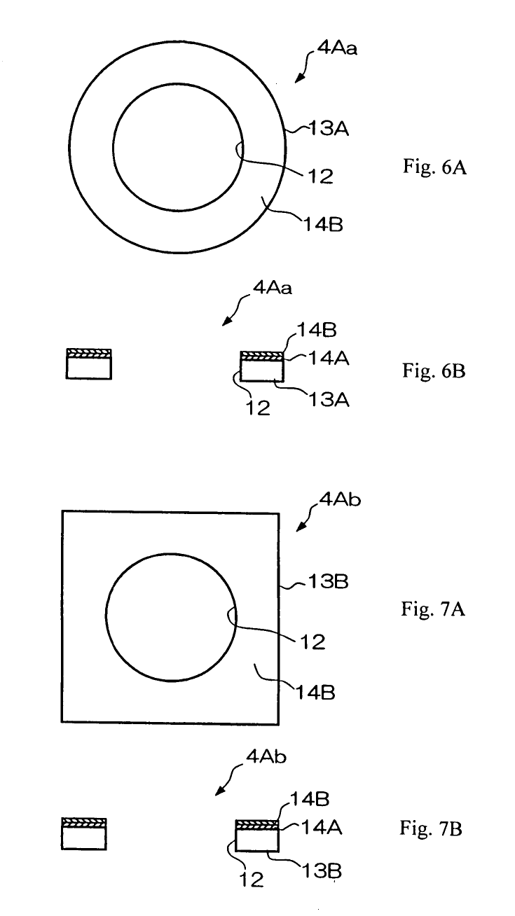

FIG. 6A is a view of an aperture limiting element 4Aa according to Embodiment 1 as seen from a position on the optical axis, and FIG. 6B is a lateral cross-sectional view of the aperture limiting element 4Aa according to this embodiment through the center of the aperture.

As shown in FIGS. 6A and 6B, the aperture limiting element 4Aa is formed of a circular aperture in a planar substrate that also has a circular shape. The substrate in the area within an outer boundary 12 of the circular aperture has been removed, for example—by drilling or by an etching process, and a wavelength filtering film 14A and a phase compensation film 14B have been applied to a surface of the transparent substrate 13A. The transparent substrate may be, for example, glass or plastic. The diameter of the aperture is smaller than the effective diameter of the objective lens 2, and corresponds to the diameter needed to provide the desired numerical aperture of the objective lens 2 for light of the second wavelength λ2.

The wavelength filtering film 14A is constructed by deposition of a high refractive index layer and a low refractive index layer, alternately, on the substrate 13A, with the alternate layers being formed so that the following Condition (1) is substantially satisfied:

n_{H}·d1=n_{L}·d2=(j+¼) Condition (1)

where

n_{H} is the index of refraction of the high refractive index layer, made of TiO₂, for example,

d1 is the thickness of the high refractive index layer,

n_{L} is the index of refraction of the low refractive index layer, made of SiO₂, for example,

d2 is the thickness of the low refractive index layer,

j is zero or a positive integer, and

λ=780 nm,

The wavelength filtering film 14A is constructed so that light of the second wavelength λ2 (i.e., λ=780 nm) that is incident onto the wavelength filtering film 14A is reflected by an interference effect. Of course, the wavelength filtering film 14A may be instead made of an absorbing film that absorbs light of the second wavelength λ2 while transmitting the wavelength λ1.

The phase compensation film 14B is constructed by deposition of SiO₂, for example, on the wavelength filtering film 14A, so that the phase compensation film 14B has a thickness such that the optical path length of light of the first wavelength λ1 that is transmitted by the substrate 13A and phase compensation film 14B and the optical path length of light of the first wavelength λ1 which passes within the outer boundary 12 of the aperture is an integer multiple of the first wavelength λ1. By installing such a phase compensation film 14B, the wave front of light focused by the objective lens is prevented from being disturbed.

By providing such construction, the numerical aperture of the objective lens can be set to a large value (0.6) for light of the first wavelength λ1 and a small value (0.45) for light of the second wavelength λ2.

### Embodiment 2

FIG. 7A is a view of an aperture limiting element 4Ab according to Embodiment 2 as seen from a position on the optical axis, and FIG. 7B is a lateral cross-sectional view of the aperture limiting element 4Ab according to this embodiment through the center of the aperture.

This aperture limiting element 4Ab is constructed in about the same way as the aperture limiting element 4Aa of the Embodiment 1; however, in this embodiment, the planar substrate 13B has a square shape, rather than a circular shape as in the previous embodiment.

### Embodiment 3

FIG. 8A is a view of an aperture limiting element 4Ac according to Embodiment 3 as seen from a position on the optical axis, and FIG. 8B is a lateral cross-sectional view of the aperture limiting element 4Ac according to this embodiment through the center of the aperture.

Whereas the aperture limiting element 4Ac is constructed about the same way as the aperture limiting element 4Aa of Embodiment 1 in its layer construction, etc., the substrate 13C of this embodiment in not planar but instead, as shown in FIG. 8B, has a very shallow, inverted V-shape cross section. In other words, the shape of the substrate 13C is that of a very shallow truncated cone with the tip of the cone removed so as to form an aperture. Were the tip of the cone present it would point upward and be centered on the optical axis. As shown in the FIG. 8B, the height of the truncated cone is very small, since the purpose of avoiding using a planar substrate is to prevent light that is specularly reflected by the substrate from traveling backward to the light-source side. Also, in this case it is preferable that the substrate 13C be formed of a plastic material so as to improve ease of manufacture and thus reduce costs. Because such a design prevents light of the second wavelength λ2 that is reflected by the aperture limiting element 4Ac from traveling backward to the light-source side, stabilization of oscillation of the light source is achieved.

### Embodiment 4

FIG. 9A is a view of an aperture limiting element 4Ad according to Embodiment 4 as seen from a position on the optical axis, and FIG. 9B is a lateral cross-sectional view of the aperture limiting element 4Ad according to this embodiment through the center of the aperture.

The aperture limiting element 4Ad of this embodiment is similar to that of the aperture limiting element 4Ac of Embodiment 3, except that the substrate 13D in this embodiment has a very shallow, V-shaped cross section instead of a very shallow, inverted V-shaped cross section. In other words, as shown in FIG. 9B, the tip of the truncated cone (were it not removed so as to form the aperture) in this embodiment points downward. Once again, as shown in FIG. 9B, the height of the truncated cone is very small, since its purpose and effect is about the same as the truncated cone substrate of Embodiment 3.

### Embodiment 5

FIG. 10A is a view of an aperture limiting element 4Ba according to Embodiment 5 as seen from a position on the optical axis, and FIG. 10B is a lateral cross-sectional view of the aperture limiting element 4Ba according to this embodiment through the center of the aperture.

This aperture limiting element 4Ba has a planar substrate that is circular in shape. Once again, an aperture is centered on the optical axis with its outer boundary being item 12. A diffraction filtering film 24A has been deposited on a transparent substrate 13E that may be made, for example, of glass or plastic. The diffraction grating which forms the diffraction filtering film 24A is formed as concentric rings (illustrated in FIG. 10A), each of which has a cross section that is rectangular in shape, as illustrated in FIG. 10B. Once again, the diameter of the aperture is set to a smaller value than the effective diameter of the objective lens 2, and the smaller value corresponds to the numerical aperture of the objective lens 2 for light of the second wavelength λ2.

Also, the diffraction filtering film 24A may be formed by deposition of SiO₂ onto the substrate 13E and then etching the substrate 13E so as to form the aperture, or by forming the aperture first and then depositing the concentric rings of SiO₂ that form the diffraction filtering film 24A. The diffraction filtering film 24A is constructed so that the height h of the diffraction grating is given by the following Conditions (2) and (3):

h=L·λ1/(n1−1) Condition (2)

h=Mλ2/(n2−1)+K·λ2/2(n2−1) Condition (3)

where

λ1, λ2 are the wavelengths of two incident light beams,

n1 is the index of refraction of the diffraction grating for light of wavelength λ1,

n2 is the index of refraction of the diffraction grating for light of wavelength λ2,

L is a positive integer,

M is the maximum value of 0 and positive integers which satisfy the condition

h>M·λ2/(n2−1)

K is a numerical value in the range of either 0.65 and higher, or 1.35 and lower.

The aperture limiting element 4Ba completely transmits light of wavelength 650 nm and diffracts most of the light of wavelength 780 nm in the surrounding area of an outer boundary 12 of the aperture. By giving it such construction, the numerical aperture of the objective lens 2 can be set to a large value (0.6) for light of the first wavelength λ1 and a small value for light of the second wavelength λ2.

### Embodiment 6

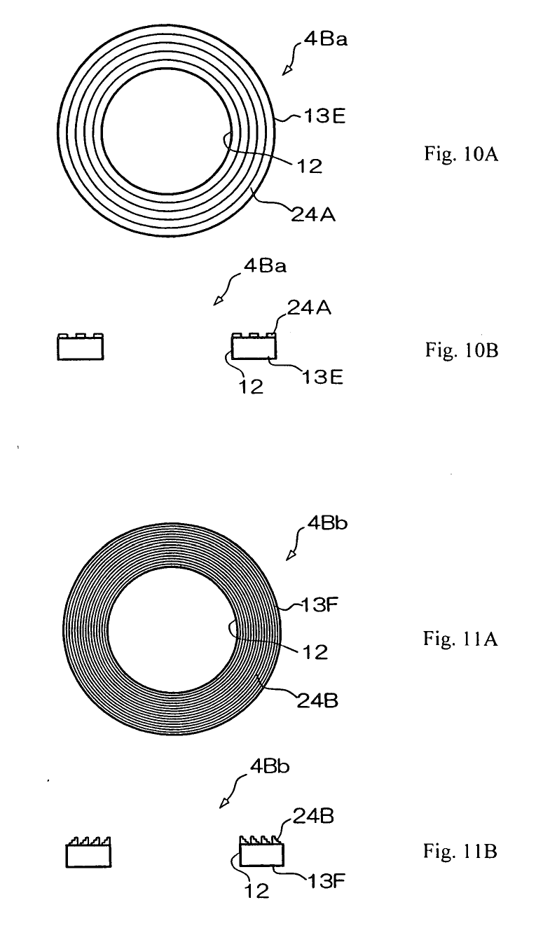

FIG. 11A is a view of an aperture limiting element 4Bb according to Embodiment 6 as seen from a position on the optical axis, and FIG. 11B is a lateral cross-sectional view of the aperture limiting element 4Bb according to this embodiment through the center of the aperture.

Whereas this aperture limiting element 4Bb is constructed about the same way as the aperture limiting element 4Ba of Embodiment 5, it is different in that in this embodiment the cross-sectional shape of the diffraction grating elements that form the diffraction filtering film 24B on the substrate 13F has the shape of a staircase, as illustrated in FIG. 11B.

This diffraction filtering film 24B is constructed so each step of the diffraction grating has a height g that satisfies the following Conditions (4) and (5):

g=L·λ1/(n1−1) Condition (4)

g=M·λ2/(n2−1)+K·λ2/2(n2−1) Condition (5)

where

λ1 and λ2 are the wavelengths of two incident light beams,

n1 is the refractive index of the diffraction grating for light of wavelength λ1,

n2 is the refractive index of the diffraction grating for light of wavelength λ2,

L is a positive integer,

M is the maximum value of 0 and the positive integers which satisfy a condition, namely,

g>Mλ2/(n2−1), and

K is a numerical value in the range of 0.27 or higher, or 1.73 or lower.

In this way, if the diffraction grating elements are constructed so as to have the shape of stairs, and the diffracted light of the first order and higher becomes either positive or negative, it makes it easier to take measures against the diffracted light becoming noise that is detected.

### Embodiment 7

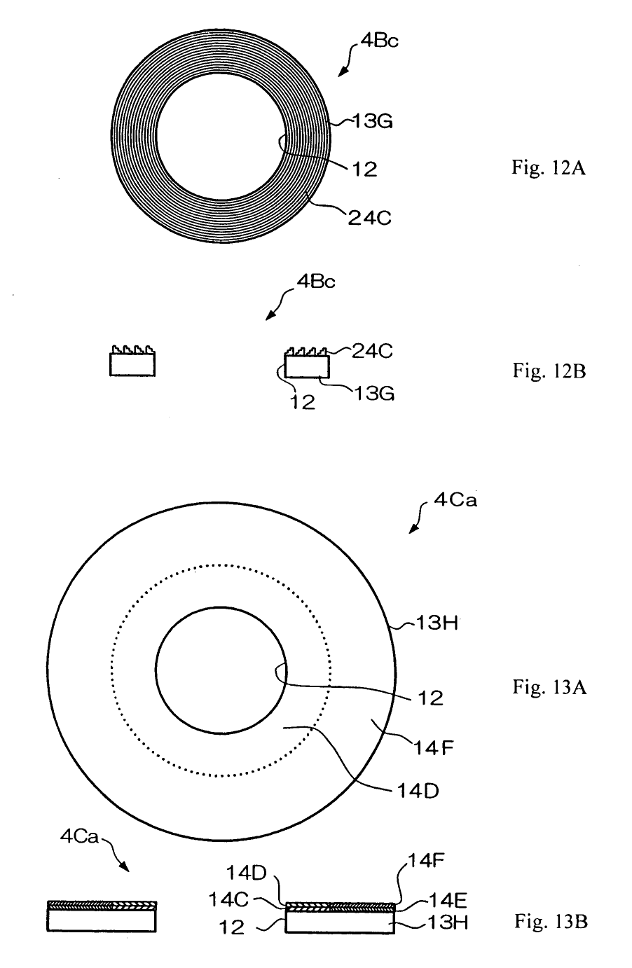

FIG. 12A is a view of an aperture limiting element 4Bc according to Embodiment 7 as seen from a position on the optical axis, and FIG. 12B is a lateral cross-sectional view of the aperture limiting element 4Bc according to this embodiment through the center of the aperture.

Whereas this aperture limiting element 4Bc is constructed about the same way as the aperture limiting element 4Bb of Embodiment 6, the direction of the stairs formed by the diffraction grating elements is different.

Also, in this aperture limiting element 4Bc just as with the aperture limiting element 4Bb, because the diffracted light of the first order and higher becomes either positive or negative, it becomes easier to take measures against the diffracted light becoming noise that is detected. Furthermore, because the direction of its steps is inward, unlike that of Embodiment 6, the +1st order diffracted light generated by this aperture limiting element 4Bc travels in a different direction from that of Embodiment 6. For example, whereas the +1st-order diffracted light in Embodiment 6 approaches the optical axis as light progresses, the +1st-order diffracted light occurring in Embodiment 7 diverges from the optical axis, making it even easier to take measures against the diffracted light being detected and becoming noise.

### Embodiment 8

FIG. 13A is a view of an aperture limiting element 4Ca according to Embodiment 8 as seen from a position on the optical axis, and FIG. 13B is a lateral cross-sectional view of the aperture limiting element 4Ca according to this embodiment through the center of the aperture.

As shown in the figures, this aperture limiting element 4Ca is formed on a planar substrate 13H that has a circular shape. Outside the outer boundary of the aperture 12 there is deposited within an inner region on the transparent substrate 13H a wavelength filtering film 14C and a phase compensation film 14D. Outside of this, within an outer region on the transparent substrate 13H is deposited a wavelength filtering film 14E and a phase compensation film 14F. The transparent substrate 13H may be made, for example, of glass or plastic, and the diameter of the aperture is set to a smaller value than the effective diameter of the objective lens 2, corresponding to the numerical aperture of the objective lens 2 for light of the third wavelength λ3.

The wavelength filtering film 14C is constructed by depositing a high refractive index layer and a low refractive index layer alternately on the inner region of the substrate 13H formed so that the following Condition (6) holds approximately true:

nH3·dI1=nL3·dI2=(j+¼)λ Condition (6)

where

nH3 is the refractive index of the high refractive index layer,

dI1 is the thickness of the high refractive index layer,

nL3 is the refractive index of the low refractive index layer,

dI2 is the thickness of the low refractive index layer,

j is zero or a positive integer, and

λis the third wavelength λ3 that is to be reflected (or absorbed) by an interference effect.

The wavelength filtering film 14E is constructed by depositing a high refractive index layer and a low refractive index layer alternately on the outer region of the substrate 13H, where they are formed so that the following Conditions (7) and (8) hold approximately true:

nH2·dO1=nL2·dO2=(k+¼)λ2 Condition (7)

nH3·dO1=nL3·dO2=(i+¼)λ3 Condition (8)

where

nH2 is the index of refraction of the high refractive index layer for wavelength λ2,

dO1 is the thickness of the high refractive index layer,

nL2 is the index of refraction of the low refractive index layer for wavelength λ2,

dO2 is the thickness of the low refractive index layer,

k is zero or a positive integer,

nH3 is the index of refraction of the high refractive index layer for wavelength λ3,

nL3 is the index of refraction of the low refractive index layer for wavelength λ3, and

i is zero or a positive integer.

Thus, these layers are constructed so that light of the second wavelength λ2 and light of the third wavelength λ3 are reflected (or absorbed) by an interference effect. TiO₂ may be used to form the high refractive index layer and SiO₂ may be used to form the low refractive index layer, for example.

On the other hand, a phase compensation film 14D and a phase compensation film 14F are constructed by depositing SiO₂, for example, on the wavelength filtering film 14C and the wavelength filtering film 14E, respectively, which compensate for the thicknesses of the wavelength filtering films 14C and 14E so that the difference between the optical path length of light of wavelength λ1 transmitted in the inner region of the substrate 13H and the two films which overlie the inner region versus the optical path length of light of wavelength λ1 which passes within the outer boundary 12 of the aperture becomes pkl (where p=1, 2, 3, . . . ) in the inner region of the substrate 13H and becomes qλ1 (where q=1, 2, 3, . . . ) in the outer region of the substrate 13H. By installing such phase compensation films 14D and 14F, the wave front of light condensed by the objective lens is prevented from being disturbed.

Also, the phase compensation film 14D compensates for the thickness of the wavelength filtering film 14C so that the difference in the optical path length of light of the second wavelength λ2 that is transmitted by the substrate 13H versus the optical path length of light of the second wavelength λ2 which passes within the outer boundary 12 of the aperture equals r·λ2 (where r=1, 2, 3, . . . ) for the inner region of the substrate 13H. By installing such a phase compensation film 14D, the wave front of light focused by the objective lens is prevented from being disturbed.

Thus, in the inner region just outside the aperture, the aperture limiting element 4Ca substantially transmits all light of wavelengths λ1 and λ2 and reflects (or absorbs) most of the light of wavelength λ3. Also, in the outer region, the aperture limiting element 4Ca substantially transmits all light of wavelength λ1 and reflects (or absorbs) most of the light of wavelengths λ2 and λ3.

By such a construction, because the aperture limiting element 4Ca achieves an effect such as that shown in FIG. 4, namely, the numerical aperture of the objective lens 2 can be set to a large value for light of wavelength λ1, an intermediate value for light of wavelength λ2, and a small value for light of wavelength λ3.

Of course, as the utilized wavelengths λ1, λ2, and λ3, various values can be adopted, and values other than those given for the present embodiments can be used.

### Embodiment 9

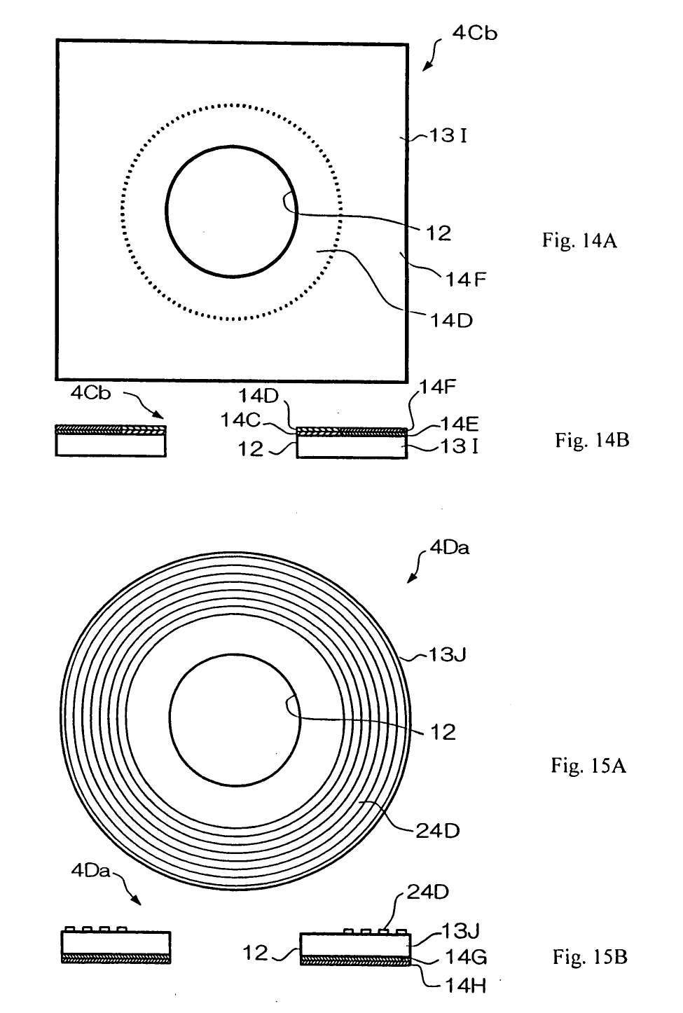

FIG. 14A is a view of an aperture limiting element 4Cb according to Embodiment 9 as seen from a position on the optical axis, and FIG. 14B is a lateral cross-sectional view of the aperture limiting element 4Cb according to this embodiment through the center of the aperture.

This aperture limiting element 4Cb is constructed about the same way as the aperture limiting element 4Ca of the Embodiment 8; however, in this embodiment the substrate 13I has a square shape rather than a circular shape.

### Embodiment 10

FIG. 15A is a view of an aperture limiting element 4Da according to Embodiment 10 as seen from a position on the optical axis, and FIG. 15B is a lateral cross-sectional view of the aperture limiting element 4Da according to this embodiment through the center of the aperture.

As shown in FIG. 15A, the aperture limiting element 4Da is formed on a planar transparent substrate 13J made of glass, plastic, etc., with a circular shape. A wavelength filtering film 14G and a phase compensation film 14H are deposited on the light-source side surface of the substrate 13J in both the inner region and the outer region. A diffraction filtering film 24D is deposited on the optical-disk-side surface of the substrate 13J in the outer region. Also, the diffraction grating of the diffraction filtering film 24D is constructed so as to have circular, concentric rings with the cross section of each having a rectangular shape, as shown in FIG. 15B. The diameter of the aperture is set to a smaller value than the effective diameter of the objective lens 2, corresponding to the numerical aperture of the objective lens 2 for light of the third wavelength λ3.

The functions of the wavelength filtering film 14G and the phase compensation film 14H are similar to those of the wavelength filtering film 14C and the phase compensation film 14D of the aperture limiting element 4Ca of Embodiment 8. The diffraction filtering film 24D may be formed, for example, by depositing SiO₂ on the substrate 13J and then etching the substrate 13J. However, other techniques are possible. The diffraction filtering film 24D is constructed so that the height h of the diffraction grating elements is given by the above Conditions (2) and (3).

In the inner region just outside the aperture, the aperture limiting element 4Da substantially transmits all light of wavelengths λ1 and λ2 and reflects (or absorbs) most of the light of wavelength λ3. Also, in the outer region, it substantially transmits all light of wavelength λ1, reflects (or absorbs) most of the light of wavelength λ3, and diffracts laterally most of the light of wavelength λ2.

By providing such a construction for the aperture limiting element 4Da, the numerical aperture of the objective lens 2 can be set to a large value for light of wavelength λ1, an intermediate value for light of wavelength λ2, and a small value for light of wavelength λ3.

Of course, as the utilized wavelengths λ1, λ2, and λ3, various values can be adopted, and values other than those given for the present embodiments can be used.

### Embodiment 11

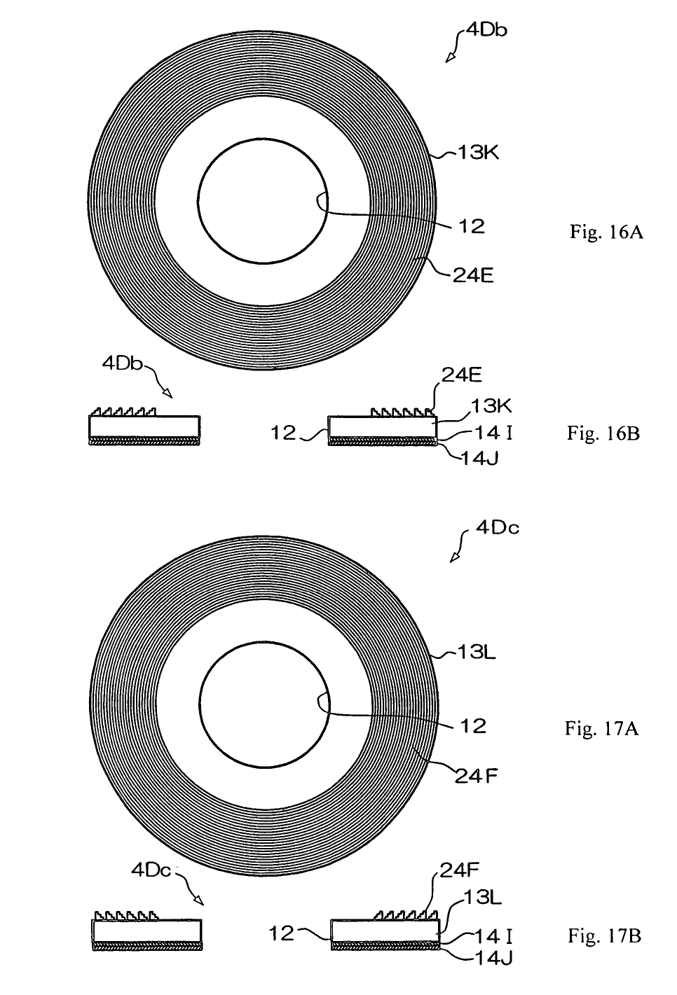

FIG. 16A is a view of an aperture limiting element 4Db according to Embodiment 11 as seen from a position on the optical axis, and FIG. 16B is a lateral cross-sectional view of the aperture limiting element 4Db according to this embodiment through the center of the aperture.

Whereas this aperture limiting element 4Db is constructed about the same way as the aperture limiting element 4Da of Embodiment 10, this embodiment differs in that the cross-sectional shape of each of the circular rings of the diffraction grating that forms the diffraction filtering film 24E on the substrate 13K has the shape of a staircase, as shown in FIG. 16B.

This diffraction filtering film 24E is constructed so that each step of the diffraction grating has a height g which satisfies the above Conditions (4) and (5).

In this way, with the diffraction grating elements formed as staircases as shown in FIG. 11B, the diffracted light of first order and higher becomes either positive or negative, making it easy to take measures against the diffracted light being detected as noise. Once again, for the utilized wavelengths λ1, λ2, and λ3, various values can be adopted.

### Embodiment 12

FIG. 17A is a view of an aperture limiting element 4Dc according to Embodiment 12 as seen from a position on the optical axis, and FIG. 17B is a lateral cross-sectional view of the aperture limiting element 4Dc according to this embodiment through the center of the aperture.

Whereas this aperture limiting element 4Dc is constructed about the same way as the aperture limiting element 4Db of Embodiment 11, the direction of the stairs formed by the diffraction grating elements of the diffraction filtering film 24F on the substrate 13L is different.

Also in this aperture limiting element 4Dc in the same way as in the aperture limiting element 4Db, because the diffracted light of the first order or higher becomes either positive or negative, it becomes easier to take measures against the diffracted light being detected as noise. Furthermore, because the direction of its steps is made inward (unlike the direction of the steps in Embodiment 11), the +1st-order diffracted light in this aperture limiting element 4Dc travels in a different direction from that in the case of Embodiment 11. For example, whereas the +1st-order diffracted light occurring in Embodiment 11 initially approaches the optical axis as the light propagates, the +1st-order diffracted light in Embodiment 12 initially diverges from the optical axis as light progresses, making it easier to take measures to insure that the diffracted light is not detected as noise.

### Embodiment 13

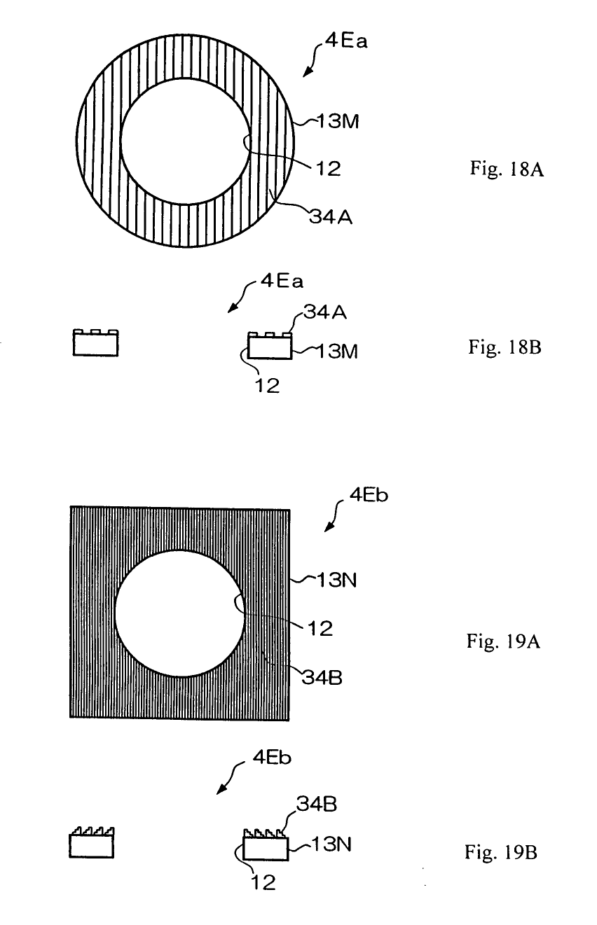

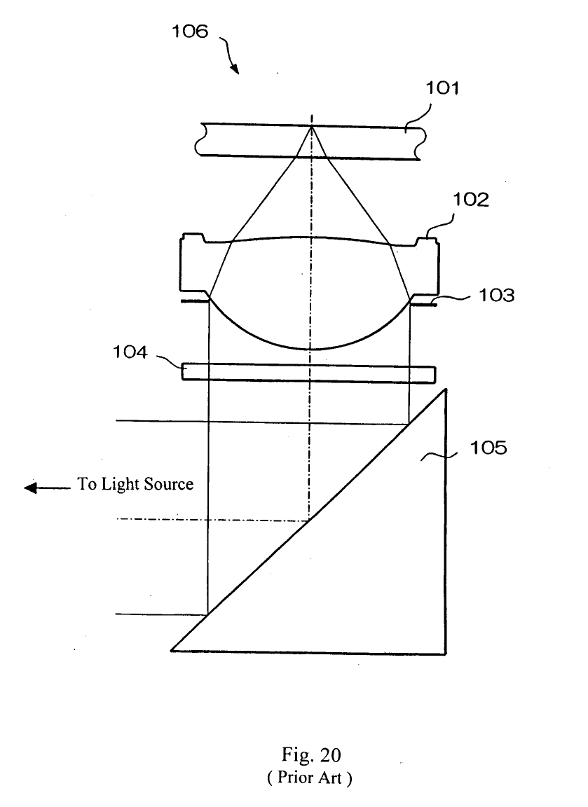

FIG. 18A is a view of an aperture limiting element 4Ea according to Embodiment 13 as seen from a position on the optical axis, and FIG. 18B is a lateral cross-sectional view of the aperture limiting element 4Ea according to this embodiment through the center of the aperture.

As shown in the figures, this aperture limiting element 4Ea is formed on a planar substrate and has an outer perimeter that is circular. In a region outside the outer boundary of a circular aperture (i.e. a hole in the substrate) a diffraction filtering film 34A is deposited onto a transparent substrate 13M that may be made of glass or plastic, for example. The aperture limiting element 4Ea of this embodiment is somewhat similar to the aperture limiting element 4Ba of Embodiment 5 in that the cross-sectional shape of each diffraction grating element is rectangular. However, the diffraction grating elements of this embodiment are aligned so as to form parallel rows rather than being formed as concentric circles as in Embodiment 5 (see FIG. 10A). It is believed that, even when the diffraction grating elements are formed as in this embodiment, a similar effect is obtained as in the case of the diffraction grating elements being formed as in Embodiment 5, making it easy to take measures to insure that the diffracted light is not detected as noise.

Note that in the same way as the aperture limiting element 4Ba of Embodiment 5, the diameter of the aperture is set to a smaller value than the effective diameter of the objective lens 2, corresponding to the numerical aperture of the objective lens 2 for light of the second wavelength λ2.

### Embodiment 14

FIG. 19A is a view of an aperture limiting element 4Eb according to Embodiment 14 as seen from a position on the optical axis, and FIG. 19B is a lateral cross-sectional view of the aperture limiting element 4Eb according to this embodiment through the center of the aperture.

As shown in the figures, this aperture limiting element 4Eb is formed on a planar substrate having a square shape. The aperture limiting element 4Eb is made by depositing a diffraction filtering film 34B on a transparent substrate 13N made of glass or plastic, for example, and is similar to the aperture limiting element 4Bb of the Embodiment 6 (see FIG. 11B) in that the cross-sectional shape of the diffraction grating elements has the form of a staircases. However, the substrate 13N has a square shape, and the diffraction grating steps, rather than being arranged in concentric rings as in Embodiment 6, has the diffraction grating steps arranged in parallel rows or columns. It is believed that, even when the diffraction grating steps are arranged in parallel rows or columns, a diffraction effect similar to that of forming the diffraction grating elements in concentric rings will be realized, making it easy to take measures to insure that the diffracted light is not detected as noise.

In the same way as the aperture limiting element 4Bb of Embodiment 6, the diameter of the aperture is set to a smaller value than the effective diameter of the objective lens 2, corresponding to the numerical aperture of the objective lens 2 for light of the second wavelength λ2.

The invention being thus described, it will be obvious that the same may be varied in many ways. For example, the aperture limiting element and optical pickup device of the present invention are not limited to those of the embodiments disclosed, as various modifications are, of course, possible. For example, in the optical pickup device of the present invention, by making the objective lens be a positive lens with a convex surface on the light-source side and constructing the optical pickup device so that the convex surface is inserted in the aperture of the aperture limiting element, it becomes unnecessary to provide additional space in the optical-axis direction for placing the aperture limiting element, and it thus becomes possible to meet the demand for thickness reduction of optical pickup devices. Also it is possible to construct an aperture limiting element and an optical pickup device utilizing it of a desired shape by combining the appropriate elements from different ones of the above-disclosed Embodiments. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An aperture limiting element that has a wavelength selectivity, comprising:
an aperture that is an open space of a specified size formed in a substrate; and
in an area outside the aperture and that surrounds the aperture, a light filter is provided wherein light of a specified wavelength λ1 is transmitted, and light of a wavelength λ2 is prevented from passing straight through.

2. The aperture limiting element according to claim 1, wherein:
the light of wavelength λ2 that is prevented from passing straight through is blocked, and λ1<λ2.

3. The aperture limiting element according to claim 1, wherein
the light of wavelength λ2 that is prevented from passing straight through is diffracted laterally, and λ1<λ2.

4. The aperture limiting element according to claim 1, wherein the construction is such that the difference in the optical path length of light of the first wavelength λ1 that is transmitted by the substrate and said filter versus the optical path length of light of the first wavelength λ1 that passes through the open space of said aperture is m·λ1, where m is a positive integer.

5. An aperture limiting element that has wavelength sensitivity comprising:
an aperture that is an open space of a specified size formed in a substrate;
in an area of the substrate that is outside the aperture, there is constructed a first light filter in an inner first region that transmits light of first and second wavelengths λ1 and λ2, respectively, and blocks light of a third wavelength λ3, where λ1<λ2<λ3; and
in an area of the substrate that is outside the inner first region, there is constructed a second light filter in an outer second region that transmits light of the first wavelength λ1 and blocks light of the second and third wavelengths λ2 and λ3, respectively.

6. An aperture limiting element that has a wavelength sensitivity comprising;
an aperture that is an open space of a specified size formed in a substrate;
in an area of the substrate that is outside the aperture, there is constructed a first light filter in an inner first region that transmits light of first and second wavelengths λ1 and λ2, respectively, and blocks light of a third wavelength λ3, where λ1<λ2<λ3; and
in an area of the substrate that is outside of the inner first region, there is constructed a second light filter in an outer second region that transmits light of the first wavelength λ1, and diffracts one and blocks the other of light of the second and the third wavelengths λ2 and λ3, respectively.

7. The aperture limiting element according to claim 5, wherein the construction is such that:
the difference in the optical path length for light of the first wavelength λ1 that is transmitted by the substrate and said filter in said inner first region versus the optical path length for light of the first wavelength λ1 that passes through the open space of said aperture is p·λ1, where p is a positive integer;
the difference in the optical path length for light of the first wavelength λ1 that is transmitted by the substrate and said filter in said outer second region versus the optical path length for light of the first wavelength λ1 that passes through the open space of said aperture is q ·λ1, where q is a positive integer; and
the difference in the optical path length for light of the second wavelength λ2 that is transmitted by the substrate and said filter in said inner first region versus the optical path length for light of the second wavelength λ2 that passes through the open space of said aperture is r·λ2, where r is a positive integer.

8. The aperture limiting element according to claim 6, wherein the construction is such that:
the difference in the optical path length for light of the first wavelength λ1 that is transmitted by the substrate and said filter in said inner first region versus the optical path length for light of the first wavelength λ1 that passes through the open space of said aperture is p·λ1, where p is a positive integer;
the difference in the optical path length for light of the first wavelength λ1 that is transmitted by the substrate and said filter in said outer second region versus the optical path length for light of the first wavelength λ1 that passes through the open space of said aperture is q ·λ1, where q is a positive integer; and
the difference in the optical path length for light of the second wavelength λ2 that is transmitted by the substrate and said filter in said inner first region versus the optical path length for light of the second wavelength λ2 that passes through the open space of said aperture is r·λ2, where r is a positive integer.

9. The aperture limiting element according to claim 1, wherein the substrate has the shape of a truncated cone.

10. The aperture limiting element according to claim 9, wherein the substrate is formed of a plastic material.

11. The aperture limiting element according to claim 3, wherein:
the ratio of the intensity of the zero-order diffracted light of the first wavelength λ1 divided by the light of the first wavelength λ1 that is transmitted by the substrate is 85% or higher; and
the ratio of the intensity of the zero-order diffracted light of the second wavelength λ2 divided by the light of the second wavelength λ2 that is transmitted by the substrate is less than the ratio of the intensity of a specified diffracted order of light of the second wavelength λ2 divided by the intensity of light of the second wavelength λ2 that is transmitted by the substrate.

12. The aperture limiting element according to claim 3, wherein the light filter is a diffraction grating having concentric circles of diffractive structures, as viewed in a direction along the optical axis of the light filter.

13. The aperture limiting element according to claim 3, wherein the light filter is a diffraction grating having diffractive structures that, in cross section, have a staircase shape.

14. The aperture limiting element according to claim 8, wherein the diffraction grating diffracts light of the second wavelength λ2 or of the third wavelength λ3 in a direction that initially diverges from the optical axis.

15. The aperture limiting element according to claim 13, wherein the diffraction grating diffracts light of the second wavelength λ2 in a direction that initially diverges from the optical axis.

16. An optical pickup device that includes an objective lens, an optical pickup element, and the aperture limiting element according to claim 1.

17. An optical pickup device that includes an objective lens, an optical pickup element, and the aperture limiting element according to claim 2.

18. An optical pickup device that includes an objective lens, an optical pickup element, and the aperture limiting element according to claim 3.

19. An optical pickup device that includes an objective lens, an optical pickup element, and the aperture limiting element according to claim 4.

20. An optical pickup device that includes an objective lens, an optical pickup element, and the aperture limiting element according to claim 5.

21. An optical pickup device that includes an objective lens, an optical pickup element, and the aperture limiting element according to claim 6.

22. The optical pickup device according to claim 16, wherein the objective lens is a positive lens having a convex surface on the light-source side arranged so that the convex surface is inserted into the open space of the aperture.

23. The aperture limiting element according to claim 5, wherein the substrate has the shape of a truncated cone.

24. The aperture limiting element according to claim 6, wherein the substrate has the shape of a truncated cone.

25. The aperture limiting element according to claim 23, wherein the substrate is formed of a plastic material.

26. The aperture limiting element according to claim 24, wherein the substrate is formed of a plastic material.

27. The aperture limiting element according to claim 6, wherein:
the ratio of the intensity of the zero-order diffracted light of the first wavelength λ1 divided by the light of the first wavelength λ1 that is transmitted by the substrate is 85% or higher; and
the ratio of the intensity of the zero-order diffracted light of the second wavelength λ2 divided by the light of the second wavelength λ2 that is transmitted by the substrate is less than the ratio of the intensity of a specified diffracted order of light of the second wavelength λ2 divided by the intensity of light of the second wavelength λ2 that is transmitted by the substrate.

28. The aperture limiting element according to claim 6, wherein the light filter is a diffraction grating having concentric circles of diffractive structures, as viewed in a direction along the optical axis of the light filter.

29. The aperture limiting element according to claim 6, wherein the light filter is a diffraction grating having diffractive structures that, in cross section, have a staircase shape.

30. The optical pickup device according to claim 20, wherein the objective lens is a positive lens having a convex surface on the light-source side arranged so that the convex surface is inserted into the open space of the aperture.

31. The optical pickup device according to claim 21, wherein the objective lens is a positive lens having a convex surface on the light-source side arranged so that the convex surface is inserted into the open space of the aperture.

32. The aperture limiting element according to claim 29, wherein the diffraction grating diffracts light of the second wavelength λ2 or of the third wavelength λ3 in a direction that initially diverges from the optical axis.
